(19) United States
(12) Patent Application Publication
(10) Pub. No.: US 2012/0026318 A1
(43) Pub. Date: Feb. 2, 2012

(54) CAMERA SYSTEM FOR DETECTING A STATE OF A VEHICLE WINDOW PANE

(76) Inventors: Michael Huelsen, Stuttgart (DE); Ulrich Seger, Leonberg-Warmbronn (DE); Matthias Karl, Ettlingen (DE); Annette Frederiksen, Renningen (DE); Roland Schmid, Stuttgart (DE); Werner Uhler, Bruchsal (DE); Norbert Hog, Appenweier (DE)

(21) Appl. No.: 13/141,279

(22) PCT Filed: Nov. 3, 2009
(86) PCT No.: PCT/EP2009/064530

§ 371 Date: Oct. 7, 2011

(30) Foreign Application Priority Data
Jan. 2, 2009 (DE) 102009000003.8

(51) Int. Cl. H04N 7/18

(52) U.S. Cl. 348/135; 348/E07.085

(57) ABSTRACT

A camera system for detecting a state of a vehicle window pane is described, having at least the following: a camera having an image sensor for detecting a first radiation emitted by the vehicle surroundings and for outputting image signals; and a radiation source for emitting a second optical radiation. At least a portion of the emitted second optical radiation is detectable by the image sensor as a function of a state of the window pane. The camera system is set up in such a way that a state of the vehicle window pane is determinable on the basis of the image signals output by the image sensor during measurements in which the vehicle window pane is illuminated differently by the second optical radiation. For this purpose, an evaluation unit which determines a state of the vehicle window pane on the basis of the image signals output by the image sensor during the measurements may be provided to record the image signals and to ascertain a state of the window pane. Measurements may be carried out in particular when the radiation source is switched on or off.

### FIELD OF THE INVENTION

The present invention relates to a camera system for detecting a state of a vehicle window pane. In addition, a vehicle having this camera system and a method for ascertaining a state of the vehicle window pane are provided.

### BACKGROUND INFORMATION

Camera systems for detecting the surroundings of a vehicle through a vehicle window pane of a vehicle, in particular a motor vehicle, are used in particular in driver assistance systems, for example in a night vision system or as a warning system. For this purpose such camera systems are designed in particular to be able to detect the space in front of the motor vehicle in the direction of travel.

Such camera systems may be used for secondary functions also known, in particular for ascertaining a state of a vehicle window pane. German Patent Application No. DE 10 2004 015 040 A1 describes such a camera system for detecting the surroundings of a vehicle through a vehicle window pane, which in addition to a primary function, such as night vision assistance and/or lane departure warning and/or traffic sign recognition and/or backing assistance, provides a secondary function in the form of a rain sensor. For this purpose the camera system has a radiation source; optical radiation emitted from the radiation source may first be coupled into, then coupled out of, the window pane, and the coupled-out portion of this optical radiation being detectable by an image sensor of a camera of the camera system. The radiation irradiated by the radiation source is coupled into the window pane in such a way that in an unwetted state of the vehicle window pane the radiation is totally reflected in the interior of the vehicle window pane until reaching the point where it is coupled out. The total reflected portion of the radiation coupled-in this way is reduced when the window pane is wetted by rainwater. The camera system may be used to ascertain the degree of wetting of the vehicle window pane on the basis of the intensity of the radiation, irradiated by the radiation source, which is reduced in this way. To prevent the radiation source from interfering with detection of the surroundings of a vehicle which is carried out using the same image sensor, the image sensor is subdivided into a first partial region for detecting the surroundings of a vehicle, and a second partial region for detecting radiation irradiated by the radiation source, overlapping of these regions being prevented by using a shutter.

Another camera system for detecting the surroundings of a vehicle through a vehicle window pane is described in German Patent Application No. DE 102 01 522 A1. In addition to a primary function such as the detection of objects, this camera system includes a secondary function such as the detection of a visual obstruction, for example as the result of raindrops on the vehicle window pane. The camera system has a camera which is focused on an outside region. The visual obstruction is ascertained by measuring the blurring of an image detected with the aid of an image sensor of the camera. In situations in which the vehicle surroundings provide too little contrast, for example at night, it is possible to temporarily switch on window pane illumination. Visual obstructions may then be detected from the scattering of the illumination light. If a visual obstruction is detected suitable measures may be taken, for example switching on a windshield wiper system or a window defogger.

### SUMMARY

According to the present invention, measurements by the image sensor at different illuminations, using second optical radiation emitted by the radiation source, are recorded and evaluated. In particular, a first measurement may be recorded with the radiation source switched on, i.e., using illumination from the second radiation, and a second measurement may be recorded with the second radiation switched off or reduced in intensity, and the image signals of the image sensor are compared to one another. In both measurements it is advantageous to also record the first optical radiation from the vehicle surroundings, so that the image signals contain information concerning both radiations.

The state of a vehicle window pane is changed as the result of damage, soiling, or a coating, in particular due to wetting with rainwater. When the vehicle window pane in a window pane state which is changed in this way is illuminated with second optical radiation from a radiation source, this results in a change in an image recorded by the image sensor, this image containing additional information compared to an image for which the vehicle window pane has been illuminated less intensely, or not at all, by second optical radiation. A state of the window pane, for example the degree of wetting of the vehicle window pane by rainwater, may be ascertained in particular by comparing image signals output in the first state or in the first measurement to image signals output in the second state or in the second measurement. This image information may be compared using, for example, an evaluation unit of the camera system. The window pane state thus ascertained may be used for initiating measures, for example switching on a windshield wiper system.

One advantageous refinement of the present invention provides that the first optical radiation and the second optical radiation are detectable together, using at least one partial region of the image sensor. The first optical radiation and the second optical radiation are preferably detectable together using the entire image sensor. The entire image sensor may thus be used for detecting the surroundings of a vehicle as well as for ascertaining a state of a window pane.

To ensure that the second optical radiation of the radiation source does not interfere with the image information of the vehicle surroundings recorded by the image sensor, the radiation source is preferably not activated in each image recording cycle of the image sensor, but instead, only in each nth image recording cycle. The frequency, the duration, and/or the brightness of the illumination of the vehicle window pane by the second optical radiation may be adjusted in particular depending on the situation, for example selected as a function of the external light conditions. Thus, the radiation source may be activated more frequently at nighttime than in daytime in order to ensure a high image detection rate of the surroundings of a vehicle during the day.

Another advantageous refinement of the present invention provides that a first partial region of the image sensor is exposed in the absence of second radiation, and a second partial region of the image sensor is exposed by second optical radiation. For example, the radiation source may be switched on only when the exposure of the first partial region of the image sensor is concluded. The second partial region of the image sensor would be exposed by first optical radiation and second optical radiation together. Such an image detection may be used in particular for image sensors which allow time-offset exposure of pixels.

### BRIEF DESCRIPTION OF THE DRAWINGS

FIG. 1 shows a sectional view of a camera system in a first specific embodiment.

FIG. 2 shows a sectional view of a camera system in a second specific embodiment.

### DETAILED DESCRIPTION OF EXAMPLE EMBODIMENTS

Identical or corresponding components are provided with the same reference numerals in the figures.

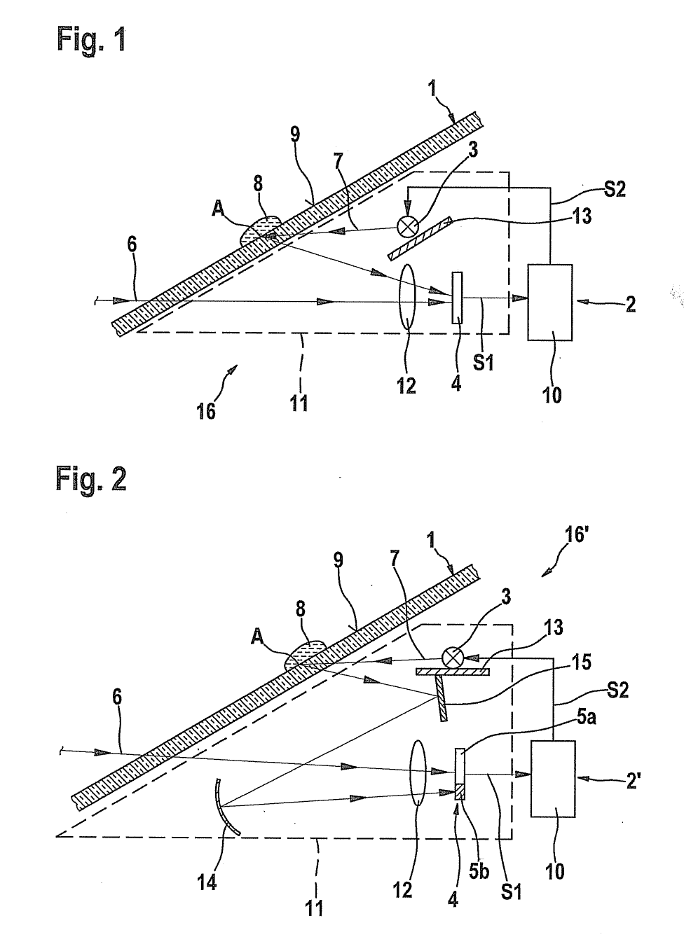

FIG. 1 schematically shows a first specific embodiment of a camera system 16 for detecting a state of a vehicle window pane.

Camera system 16 includes a camera 2 having a camera housing 11 which is only indicated, the camera being situated in the interior of a vehicle (not illustrated in greater detail) on a vehicle window pane 1, in the present case a windshield. Camera 2 includes an image sensor 4 and camera optics 12, in the present case represented by a lens, situated in front of image sensor 4. Image sensor 4 is designed on the basis of a semiconductor, in particular as a CMOS or CCD sensor, and emits image signals S1.

Camera system 16 also has an evaluation unit 10 for recording and evaluating image signals S1. Camera 2 is situated in such a way that a first optical radiation 6 generated by the vehicle surroundings through vehicle window pane 1 and camera lens 12 is detectable by image sensor 4. Camera lens 12 is preferably focused on an infinite distance, so that the vehicle surroundings are sharply imaged on image sensor 4 while ensuring a sufficient depth of field.

Camera system 16 also includes a radiation source 3 for emitting a second optical radiation 7. Radiation source 3 has one or several LEDs, for example, and is situated in or on camera housing 11 in such a way that at least a section A of vehicle window pane 1 may be illuminated by second optical radiation 7, but direct illumination of camera lens 12 and of image sensor 4 by second optical radiation 7 is prevented, for example by using a shielding element 13. Section A of vehicle window pane 1 which may be illuminated by radiation source 3 is situated in the detection range of camera lens 12, so that a portion of second optical radiation 7 may be indirectly detected by image sensor 4 via illumination of section A of vehicle window pane 1. In the present exemplary embodiment, a sufficiently large section A of vehicle window pane 1 is illuminated so that first optical radiation 6 as well as a portion of second optical radiation 7 together is detectable by the entire image sensor 4, the portion of second optical radiation 7 which is detected by image sensor 4 being a function of the state of the external, i.e., outside, window pane surface 9.

If vehicle window pane 1 is soiled, for example if a raindrop 8 is present on window pane surface 9 in the region of section A, this soiling results in an altered beam path and/or an altered spectrum of optical radiation 7, in particular due to scattering, reflection, and/or refraction. Thus, image signals S1 output by image sensor 4 in the state illuminated by radiation source 3 differ from image signals Si which have been recorded in a state of vehicle window pane 1 in which vehicle window pane 1 is not soiled and is not wetted by rainwater. The illustration of the portions of second optical radiation 7 which are scattered or reflected at the boundary surfaces have been omitted from the figure for the sake of clarity.

Radiation source 3 is controlled, for example, by evaluation unit 10 via control signals S2. According to the present invention, in particular at least two states of radiation source 3 may be set in which radiation source 3 emits different second radiation 7, i.e., radiation which differs in particular with respect to intensity, or alternatively or additionally, also with respect to the spectral composition and/or angular distribution and/or polarity. In each of these two states measurements are made using camera 2, and image signals S1 thereof are recorded and evaluated by evaluation unit 10. In this regard, the association of obtained image signals S1 with the various measurements is relevant; radiation source 3 may also be controlled by a further control unit via control signals S2, and the evaluation unit may receive appropriate signals for synchronizing this control unit; in this case the combination of the further control unit with the unit which carries out the evaluation and assessment corresponds to evaluation unit 10, shown in FIGS. 1 and 2.

In particular, a first measurement may be made using active radiation source 3, i.e., using illuminated section A, and a second measurement may be made without illuminating section A, in particular with radiation source 3 switched off. For the first measurement with illumination of section A of vehicle window pane 1 by second optical radiation 7, in each nth image recording cycle, where n is an integer greater than 1, preferably greater than 10, radiation source 3 is switched on for the entire image recording cycle; i.e., at least one frame is output. Radiation source 3 is deactivated for the remaining image recording cycles. Thus, image signal S1 includes image information from each nth image or frame which represents superimposition of first and second optical radiation 6, 7.

The remaining images include image information from image signals S1 which are based on first optical radiation 6 in the absence of second optical radiation 7, i.e., which represents vehicle surroundings without interference from second optical radiation 7.

In addition, the frequency, the brightness, and/or the duration of the illumination of vehicle window pane 1 may be adjusted by second optical radiation 7, depending on the situation. Thus, for example, the rate at which an image is recorded when vehicle window pane 1 is illuminated by second optical radiation 7 may be increased or decreased as a function of the light conditions in the vehicle surroundings. In addition, multiple images may be recorded in succession with radiation source 3 activated. These measures are particularly advantageous under poor light conditions, for example at night, in which a lower image rate of images which represent the vehicle surroundings without interference by second optical radiation 7 may be obtained. A change in the brightness of radiation source 3 is advantageous in order to take into account a change in the brightness of first optical radiation 6, for example in order to achieve a discernible superimposition of first optical radiation 6 by second optical radiation 7 for an advantageous evaluation, but to avoid over-irradiation.

In one alternative specific embodiment, radiation source 3 is activated over only a portion of, not an entire, image recording cycle, as the result of which a first partial region of image sensor 4 is exposed by first optical radiation 6 and second optical radiation 7, and a second partial region is exposed in the absence of second optical radiation 7. In this regard image sensor 4 is designed as an image sensor 4 in which pixels are exposed or read out in a time-offset manner. Such a single image which is recorded by image sensor 4 thus contains image information which is based on first optical radiation 6 in the absence of second optical radiation 7, as well as first optical radiation 6 which is overlapped with second optical radiation 7. The image information which is not influenced by second optical radiation 7 may be evaluated for detecting the surroundings of a vehicle. The other image information may be designated for determining a window pane state, for example as described above by a comparison with image information for which the illumination of vehicle window pane 1 is deactivated.

FIG. 2 shows a schematic illustration of a second specific embodiment of a camera system 16′ according to the present invention, having a camera 2′ for detecting a state of a vehicle window pane 1. Camera system 16′ according to the second specific embodiment corresponds in important points to the first specific embodiment of camera system 16 shown in FIG. 1; only the differences are discussed below. In contrast to the first specific embodiment, in addition to camera lens 12 second camera system 16′ has an auxiliary camera lens which is focused in the region of section A of vehicle window pane 1, so that section A is sharply imaged on image sensor 4. The auxiliary camera lens includes a concave mirror 14 and a deflecting mirror 15. Concave mirror 14 is situated in the detection range of camera lens 12. In addition, section A of vehicle window pane 1 which may be illuminated by radiation source 3 may be imaged on a second partial region 5b of image sensor 4, it not being possible for second optical radiation 7 to irradiate the remainder of image sensor 4, which forms a partial region 5a. Alternatively, the second camera system may be designed similarly to the first camera system in such a way that the entire image sensor 4 is used for detecting first optical radiation 6 and second optical radiation 7. Focusing of section A of vehicle window pane 1 allows in particular the analysis of details on vehicle window pane 1, for example detection of scratches. The image recording and the evaluation may be carried out similarly as for the first specific embodiment of camera system 16. Alternatively, the auxiliary camera lens may be made up of different optical elements or include additional optical elements, for example lenses or optical diffraction gratings.

1-15. (canceled)

16. A camera system for detecting a state of a vehicle window pane, comprising:
a camera having an image sensor to detect a first radiation emitted by vehicle surroundings and for outputting image signals;
a radiation source to emit a second optical radiation, at least a portion of the emitted second optical radiation being detectable by the image sensor as a function of a state of the window pane;
wherein the camera system is arranged in such a way that a state of the vehicle window pane is determinable on the basis of the image signals output by the image sensor during measurements in which the vehicle window pane is illuminated differently by the second optical radiation.

17. The camera system as recited in claim 1, further comprising:
an evaluation unit configured to record the image signals and ascertain a state of the vehicle window pane, the evaluation unit determining a state of the vehicle window pane from the image signals output by the image sensor during the measurements in which the vehicle window pane is illuminated differently by the second optical radiation.

18. The camera system as recited in claim 17, wherein the evaluation unit receives image signals from the image sensor based on at least one first measurement and one second measurement, in which the radiation source emits the second optical radiation with at least one of a different intensity, a different spectral composition, different radiation characteristics, and different polarity.

19. The camera system as recited in claim 16, wherein the first optical radiation and the second optical radiation together are detectable with the aid of at least one partial region of the image sensor.

20. The camera system as recited in claim 16, wherein the camera system is arranged in such a way that at least a portion of the second optical radiation is guided in places through an interior of the vehicle window pane before the detection by the image sensor.

21. The camera system as recited in claim 16, wherein the radiation source is situated in such a way that the second optical radiation is irradiated into the vehicle window pane in an angular range in such a way that in an unwetted window pane state, at least a portion of the second optical radiation is not totally reflected within the vehicle window pane.

22. The camera system as recited in claim 16, wherein the radiation source is situated in such a way that the vehicle window pane may be illuminated by the second optical radiation from a vehicle interior.

23. The camera system as recited in claim 16, wherein the camera system is arranged in such a way that in at least one image recording cycle, at least a partial region of the image sensor is illuminated by the first optical radiation in an absence of the second optical radiation, and time offset thereto at least a partial region of the image sensor is exposed by the first optical radiation and the second optical radiation.

24. The camera system as recited in claim 23, wherein in the image recording cycle a first partial region and a second partial region of the image sensor are configured for a time-offset exposure with respect to one another, the first partial region being exposed in the absence of the second optical radiation, and the second partial region being exposed by the second optical radiation.

25. The camera system as recited in claim 23, wherein in a first image recording cycle the image sensor is exposed in the absence of the second optical radiation, and in a second image recording cycle the image sensor is exposed by the second optical radiation.

26. The camera system as recited in claim 16, wherein the camera system is arranged in such a way that at least one of a frequency, duration, and brightness of the illumination of the vehicle window pane by the second optical radiation is adjusted as a function of light conditions in the vehicle surroundings.

27. The camera system as recited in claim 16, wherein the camera system is arranged in such a way that at least one section of the vehicle window pane which may be irradiated by second optical radiation may be sharply imaged on the image sensor.

28. The camera system as recited in claim 27, wherein the camera system includes a camera lens and an auxiliary lens, the auxiliary lens being focused in the region of section of the vehicle window pane.

29. A vehicle, comprising:
a vehicle window pane; and
a camera system situated on the vehicle window pane, the camera system for detecting a state of the vehicle window pane, the camera system including a camera having an image sensor to detect a first radiation emitted by vehicle surroundings and for outputting image signals, and a radiation source to emit a second optical radiation, at least a portion of the emitted second optical radiation being detectable by the image sensor as a function of a state of the window pane; wherein the camera system is arranged in such a way that a state of the vehicle window pane is determinable on the basis of the image signals output by the image sensor during measurements in which the vehicle window pane is illuminated differently by the second optical radiation.

30. A method for ascertaining a state of a vehicle window pane, comprising:
detecting first optical radiation from surroundings of a vehicle by an image sensor through a vehicle window pane; and
emitting a second optical radiation by a radiation source in such a way that at least a portion of the emitted second optical radiation is detectable by the image sensor as a function of a state of the window pane;
wherein at least two measurements of the image sensor are made in which the vehicle window pane is illuminated differently by the second optical radiation, and a state of the vehicle window pane is based on image signals of the image sensor output during the measurements.
